(19) United States
(12) Patent Application Publication
(10) Pub. No.: US 2022/0364961 A1
(43) Pub. Date: Nov. 17, 2022

(54) SYSTEMS AND METHODS FOR PROCESSING BIOLOGICAL SPECIMENS

(71) Applicant: STRATEOS, INC., Menlo Park, CA (US)

(72) Inventors: CHRISTOPHER RHODES, Oakland, CA (US); Gregory DeFoe, San Bruno, CA (US); Corey Monteith, San Francisco, CA (US); Joseph Springer, Mill Valley, CA (US); Kristy Parker, Denver, CO (US)

(21) Appl. No.: 17/739,437

(22) Filed: May 9, 2022

Related U.S. Application Data
(60) Provisional application No. 63/189,308, filed on May 17, 2021.

(51) Int. Cl. G01N 1/31; G01N 35/00; G01N 35/10

(52) U.S. Cl. CPC G01N 1/312; G01N 35/00029; G01N 35/1002

(57) ABSTRACT

Method and system for processing biological specimens. For example, the method includes loading a plurality of biological specimens on a continuous substrate at a plurality of spaced-apart locations on the continuous substrate, attaching a plurality of wells to the continuous tape substrate corresponding to the plurality of spaced-apart locations where each well surrounds a respective biological specimen on the continuous substrate, performing one or more chemical processes on the respective biological specimen contained in the each well of the plurality of wells, and analyzing results of the one or more chemical processes on the respective biological specimen contained in the each well of the plurality of wells.

### CROSS-REFERENCE TO RELATED APPLICATIONS

This application claims priority to U.S. Provisional Patent Application No. 63/189,308, filed May 17, 2021, incorporated by reference herein for all purposes.

The following two applications, including this one, are being filed concurrently and the other application is hereby incorporated by reference in its entirety for all purposes:

1. U.S. patent application Ser. No. ______, titled “Devices and Methods for Handling Biological Specimens” (Attorney Docket Number 520295.000012); and

2. U.S. patent application Ser. No. ______, titled “Systems and Methods for Processing Biological Specimens” (Attorney Docket Number 520295.000013).

### FIELD OF THE DISCLOSURE

Some embodiments of the present disclosure are directed to processing biological specimens. More particularly, certain embodiments of the present disclosure provide systems and methods for chemically processing an array of biological specimens simultaneously. Merely by way of example, the present disclosure has been applied to process the array of biological specimens to improve throughput. But it would be recognized that the present disclosure has much broader range of applicability.

### BACKGROUND OF THE DISCLOSURE

It is often desired to chemically process biological specimens for subsequent analysis. For example, the biological specimens may be stained for various imaging purposes. Conventional methods rely on the user of glass slides which limit throughput. Accordingly, there exists a need to develop techniques that can improve the processing of biological specimens.

### BRIEF SUMMARY OF THE DISCLOSURE

Some embodiments of the present disclosure are directed to processing biological specimens. More particularly, certain embodiments of the present disclosure provide systems and methods for chemically processing an array of biological specimens simultaneously. Merely by way of example, the present disclosure has been applied to process the array of biological specimens to improve throughput. But it would be recognized that the present disclosure has much broader range of applicability.

According to certain embodiments, a method for processing biological specimens includes loading a plurality of biological specimens on a continuous substrate at a plurality of spaced-apart locations on the continuous substrate. Also, the method includes attaching a plurality of wells to the continuous substrate corresponding to the plurality of spaced-apart locations. Each well of the plurality of wells is configured to surround a respective biological specimen of the plurality of biological specimens on the continuous substrate. Further, the method includes performing one or more chemical processes on the respective biological specimen contained in the each well of the plurality of wells. Moreover, the method includes analyzing results of the one or more chemical processes on the respective biological specimen contained in the each well of the plurality of wells.

According to some embodiments, a system for processing biological specimens includes one or more processors and a memory storing instructions for execution by the one or more processors. The instructions, when executed by the one or more processors, cause the system to load a plurality of biological specimens on a continuous substrate at a plurality of spaced-apart locations on the continuous substrate. Also, the instructions, when executed by the one or more processors, cause the system to attach a plurality of wells to the continuous substrate corresponding to the plurality of spaced-apart locations. Each well of the plurality of wells is configured to surround a respective biological specimen of the plurality of biological specimens on the continuous substrate. Further, the instructions, when executed by the one or more processors, cause the system to perform one or more chemical processes on the respective biological specimen contained in the each well of the plurality of wells. Moreover, the instructions, when executed by the one or more processors, cause the system to process results of the one or more chemical processes on the respective biological specimen contained in the each well of the plurality of wells.

Depending upon the embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1A to FIG. 1D show simplified devices for handling biological specimens according to certain embodiments of the present disclosure.

FIG. 2 shows a simplified method for handling biological specimens according to certain embodiments of the present disclosure.

FIG. 3 shows a simplified method for processing biological specimens according to certain embodiments of the present disclosure.

FIG. 4 shows a simplified system for processing biological specimens according to certain embodiments of the present disclosure.

FIG. 5 shows a simplified system of an automated workcell for processing biological specimens according to certain embodiments of the present disclosure.

FIG. 6 to FIG. 19 show simplified diagrams of workflows for processing biological specimens according to certain embodiments of the present disclosure.

### DETAILED DESCRIPTION OF THE DISCLOSURE

Some embodiments of the present disclosure are directed to processing biological specimens. More particularly, certain embodiments of the present disclosure provide systems and methods for chemically processing an array of biological specimens simultaneously. Merely by way of example, the present disclosure has been applied to process the array of biological specimens to improve throughput. But it would be recognized that the present disclosure has much broader range of applicability.

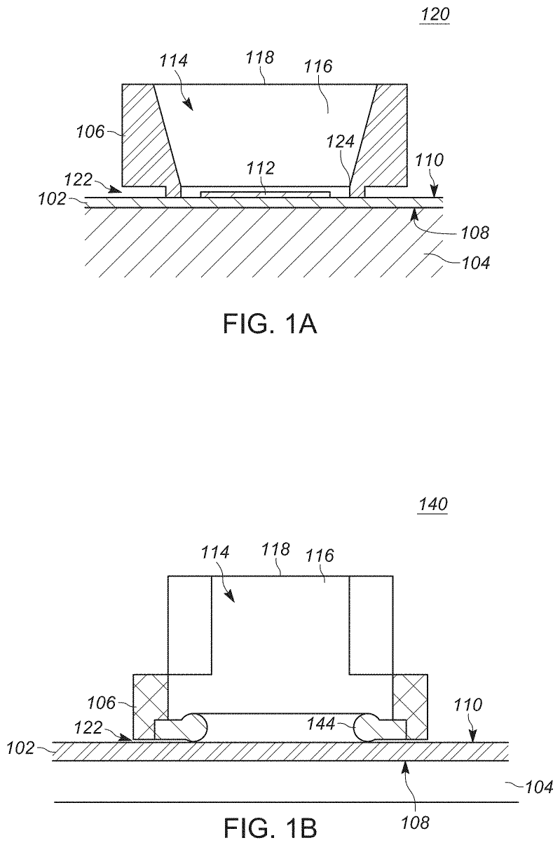

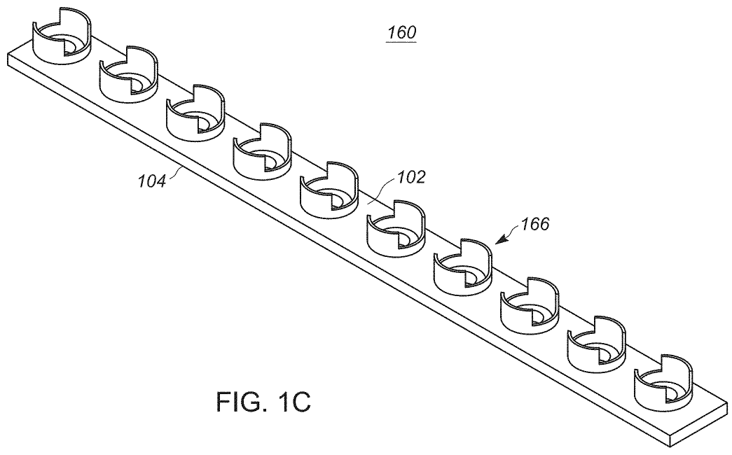

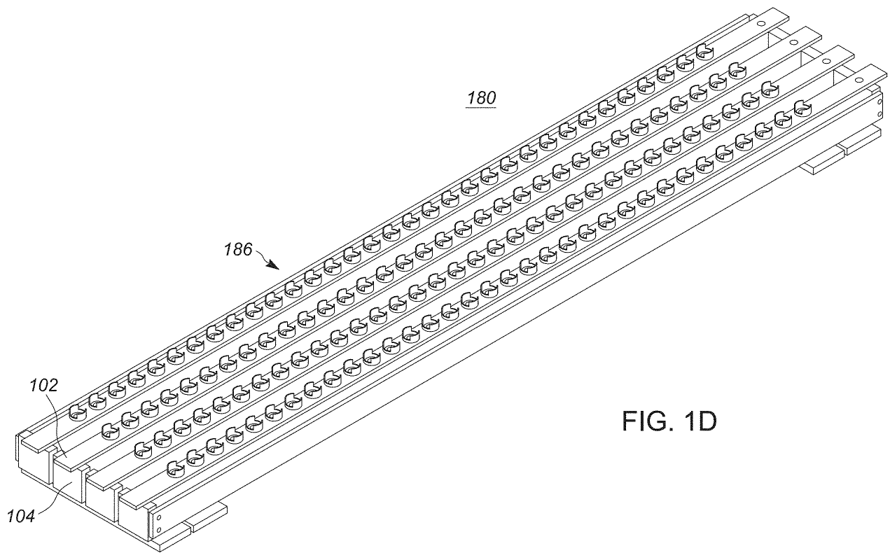

FIG. 1A to FIG. 1D show simplified devices for handling biological specimens according to certain embodiments of the present disclosure. The figures are merely examples, which should not unduly limit the scope of the claims. One of ordinary skill in the art would recognize many variations, alternatives, and modifications. In various embodiments, the device 120 in FIG. 1A, the device 140 in FIG. 1B, the device 160 in FIG. 1C, and the device 180 in FIG. 1D include a substrate 102 and a base 104. Although the above has been shown using a selected group of components for the system, there can be many alternatives, modifications, and variations. For example, some of the components may be expanded and/or combined. Other components may be inserted to those noted above. Depending upon the embodiment, the arrangement of components may be interchanged with others replaced.

In some embodiments, the substrate 102 includes a first surface 108 and a second surface 110. For example, the first surface 108 is disposed on the base 104, and the second surface 110 is configured to support a biological specimen 112 (e.g., a tissue section, a blood sample, etc.).

In various embodiments, the substrate 102 is continuous. For example, the substrate 102 is formed by a continuous sheet. In some embodiments, the substrate 102 may be flexible, foldable, rollable, stretchable, etc. In certain embodiments, the substrate 102 may be rigid. In some embodiments, the substrate 102 includes an adhesive film such as a tape. For example, the second surface 110 of the substrate 102 includes the adhesive film that allows the biological specimen 112 to be attached to the second surface 110. In certain embodiments, the substrate 102 includes a non-adhesive film.

In FIG. 1A and FIG. 1B, a compressive element 106 is disposed on the second surface 110 of the substrate 102 to surround the biological specimen 112 according to certain embodiments. In some embodiments, the compressive element 106 includes an opening 114 opposite the second surface 110 of the substrate 102 on which the compressive element 106 is placed. For example, the opening 114 is configured to form a well 116. As an example, the well 116 is an open well that allows one or more reagents to be introduced into the well 116. In various embodiments, the well 116 is configured to receive a cover 118 to close the opening 114.

In certain embodiments, the compressive element 106 and the base 104 cooperate to secure the compressive element 106 to the substrate 102. For example, the base 104 includes a first magnetic material (e.g., a permanent magnet) and the compressive element 106 includes a second magnetic material (e.g., a metal). As an example, the second magnetic material of the compressive element 106 is magnetically attracted to the first magnetic material of the base 104 such that the compressive element 106 is secured on the substrate 102. For example, the magnetic attraction between the compressive element 106 and the base 104 allows the well 116 to be securely held in place. In some examples, other suitable means (e.g., pneumatic, mechanical, or hydraulic mechanism) can be used to create and secure the well 116 on the substrate 102. In certain examples, mechanisms that use neither magnetic nor pneumatic/hydraulic forces can be used to create and secure the well 116 on the substrate 102.

In some embodiments, contact between the compressive element 106 and the base 104 forms a seal 122. For example, once the well 116 is created, the one or more reagents can be introduced into the well 116 for chemically processing the biological specimen 114. As an example, the seal 122 is configured to retain the one or more reagents in the well 116. In FIG. 1A, the seal 122 is formed by a section 124 of the compressive element 106 according to certain embodiments. For example, the section 124 is in direct contact with the second surface 110 of the substrate 102 to form the seal 122. As an example, the section 124 of the compressive element 106 is a ring-shaped boss machined from stainless steel. In FIG. 1B, the seal 122 is formed by an elastomer element 144 according to certain embodiments. For example, the elastomer element 144 (e.g., a washer, an O-ring, etc.) is disposed between the compressive element 106 and the second surface 110 of the substrate 102 to form the seal 122.

In FIG. 1C, a plurality of compressive elements 166 are disposed on the second surface 110 of the substrate 102 according to certain embodiments. For example, the plurality of compressive elements 166 are arranged along a single row. In FIG. 1D, a plurality of compressive elements 186 are disposed on the second surface 110 of the substrate 102 according to certain embodiments. As an example, the plurality of compressive elements 186 are arranged in multiple parallel rows.

In various embodiments, throughput improvements can be realized with a continuous substrate mounted with multiple wells. In certain embodiments, the multiple wells are configured as a liquid handling station in an addressable array such that each well assumes a known spatial position and is independently available for any chemical processing. In some embodiments, each well is positioned on the continuous substrate in a way that aligns the position of each well to a corresponding biological specimen. For example, N biological specimens are arranged in a row with the same center-to-center spacing D, and each well is positioned onto the continuous substrate with the same spacing. As an example, once N wells are aligned with N biological specimens, chemical processing can be performed in each well. For example, the wells are detached after chemical processing and the continuous substrate is mounted with another set of N biological specimens and N wells to repeat the procedure.

In certain embodiments, each biological specimen is identified virtually (e.g., its position known from prior information of its relative order on the substrate). In some embodiments, each biological specimen is identified physically (e.g., by printing or engraving an identification label such as alphanumeric characters, barcodes, etc.) on at least one layer of the continuous substrate. For example, the identification labels contain metadata such as an absolute position of the biological specimen on the continuous substrate, a relative position of the biological specimen on the continuous substrate to aid image registration, information on the origin of the biological specimen, instructions for the intended chemical process of the biological specimen, etc.

In some embodiments, by recording the address of a well each time that chemical processing is performed and by recording the spatial description of each biological specimen when loaded onto the continuous substrate, the relationship between each biological specimen and its sequence in the chemical processing can be retained for future use. For example, this relationship is recorded in electronic media (e.g., by inserting into a database during each step of a workflow). As an example, this relationship is useful when interpreting stained features of multichannel Z-stacks or in the correlation of specific transcript signals with spatial position in tissues.

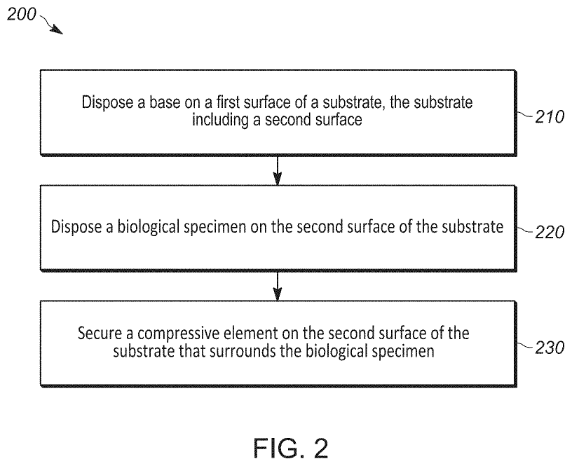

FIG. 2 shows a simplified method for handling biological specimens according to certain embodiments of the present disclosure. This figure is merely an example, which should not unduly limit the scope of the claims. One of ordinary skill in the art would recognize many variations, alternatives, and modifications. The method 200 includes process 210 for disposing a base, process 220 for disposing a biological specimen, and process 230 for securing a compressive element. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced. For example, some or all processes of the method are performed by a computing device or a processor directed by instructions stored in memory. As an example, some or all processes of the method are performed according to instructions stored in a non-transitory computer-readable medium.

At the process 210, the base is disposed on a first surface of a substrate according to certain embodiments. In some embodiments, the substrate includes a second surface. In certain embodiments, the substrate is formed by a continuous piece of tape that is flexible, foldable, rollable, stretchable, etc.

At the process 220, the biological specimen is disposed on the second surface of the substrate according to certain embodiments. In some embodiments, the second surface of the substrate includes an adhesive film that allows the biological specimen to be attached to the second surface.

At the process 230, the compressive element is secured on the second surface of the substrate that surrounds the biological specimen according to certain embodiments. In some embodiments, the compressive element includes an opening opposite the second surface of the substrate on which the compressive element is placed. For example, the opening is configured to form a well that allows one or more reagents to be introduced into the well for chemically processing the biological specimen.

In certain embodiments, the compressive element and the base cooperate to secure the compressive element to the substrate to form a seal which is configured to retain the one or more reagents in the well. In some examples, the seal is formed by a section of the compressive element in direct contact with the second surface of the substrate. In certain examples, the seal is formed by an elastomer element disposed between the compressive element and the second surface of the substrate.

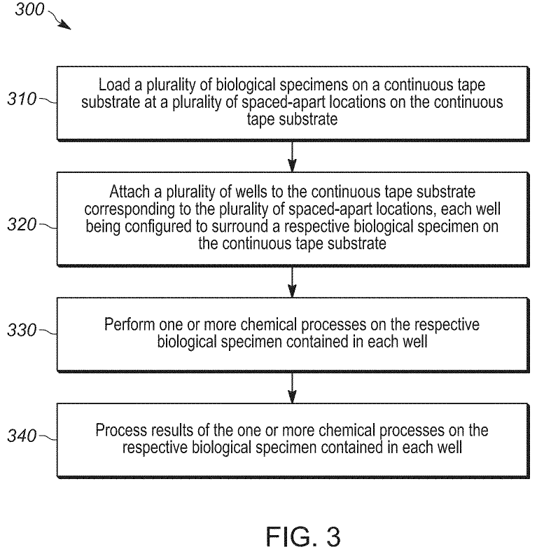

FIG. 3 shows a simplified method for processing biological specimens according to certain embodiments of the present disclosure. This figure is merely an example, which should not unduly limit the scope of the claims. One of ordinary skill in the art would recognize many variations, alternatives, and modifications. The method 300 includes process 310 for loading biological specimens, process 320 for attaching wells, process 330 for performing chemical processes, and process 340 for analyzing results. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced. For example, some or all processes of the method are performed by a computing device or a processor directed by instructions stored in memory. As an example, some or all processes of the method are performed according to instructions stored in a non-transitory computer-readable medium.

At the process 310, a plurality of biological specimens are loaded on a continuous substrate according to certain embodiments. For example, the continuous substrate is a strip of tape that is flexible, foldable, rollable, stretchable, etc. In some embodiments, the plurality of biological specimens are loaded at a plurality of spaced-apart locations on the continuous substrate. For example, the plurality of biological specimens are placed at designated locations on the continuous substrate. In certain embodiments, machine vision can be employed to automatically align and verify the placement of the plurality of biological specimens at the plurality of spaced-apart locations on the continuous substrate.

At the process 320, a plurality of wells are attached to the continuous substrate corresponding to the plurality of spaced-apart locations according to certain embodiments. In various embodiments, each well is configured to surround a respective biological specimen on the continuous substrate. In some embodiments, attaching the plurality of wells includes sealing each well so that reagents can be introduced into the well. In certain embodiments, each well may be protected by receiving a cover. In some embodiments, a gripper can be employed to automatically attach the plurality of wells to the continuous substrate as well as to cover or uncover each well.

In certain embodiments, the plurality of biological specimens are uncovered prior to attaching the plurality of wells to the continuous substrate. For example, each biological specimen may be protected by a cover (e.g., protective liner). As an example, the cover is removed so that subsequent chemical processing can take place. In some embodiments, a tape roller can be employed to automatically uncover the plurality of biological specimens.

At the process 330, one or more chemical processes are performed on the respective biological specimen contained in each well according to certain embodiments. In various embodiments, performing the one or more chemical processes includes adding one or more reagents to the respective biological specimen contained in the each well. For example, each well is filled with a reagent that interacts with the respective biological specimen. In various embodiments, chemically processing a biological specimen involves dispensing the reagent, waiting for the reagent to interact with the biological specimen, and then removing the reagent. In certain embodiments, a robot can be employed to automatically pipette reagents (or other liquids) in and out of each well. For example, the robot is a pipette head on a gantry.

In some embodiments, the plurality of wells are detached from the continuous substrate after performing the one or more chemical processes. In certain embodiments, a gripper can be employed to automatically detach the plurality of wells from the continuous substrate. In some embodiments, following detachment of the plurality of wells, the plurality of biological specimens are covered for protection. For example, each biological specimen is laminated with another cover. In certain embodiments, a tape roller can be employed to automatically cover the plurality of biological specimens.

At the process 340, the results of the one or more chemical processes on the respective biological specimen contained in each well are processed according to certain embodiments. For example, one or more imaging or other techniques are employed to process (e.g., analyze) the results. As an example, processing the results includes an operator reviewing digital images and selecting any number of the one or more chemical processes for manual analysis. In various embodiments, one or more processes of the method 300 may be repeated sequentially for any desired number of times.

In some embodiments, spatial coordinates of each well on the continuous substrate are recorded such that the relationship between the biological specimen in each well and any subsequent chemical processing on that biological specimen in the well can be retained for future use.

In certain embodiments, the spatial coordinates of one or more first wells that surround one or more first biological specimens respectively are identified and recorded. For example, one or more first chemical processes may be performed on the one or more first biological specimens. As an example, the spatial coordinates of the one or more first wells subject to the one or more first chemical processes are identified and recorded.

In some embodiments, the spatial coordinates of one or more second wells that surround one or more second biological specimens respectively are identified and recorded. For example, one or more second chemical processes may be performed on the one or more second biological specimens. As an example, the spatial coordinates of the one or more second wells subject to the one or more second chemical processes are identified and recorded. In certain embodiments, the one or more second wells may not be subject to any chemical processes. For example, the spatial coordinates of the one or more second wells not subject to any chemical processes are also identified and recorded.

In some embodiments, the one or more chemical processes include a deparaffinization (DP) process, a histological staining (HIS) process, an antigen retrieval (AR) process, an immunohistochemical staining (IHC) process, a lysis (LP) process, an immunofluorescence staining (IF) process, an in situ hybridization (ISH) process, a spatial transcriptomics (ST) process, mounting cover film (MT) process, and/or a cell culture development (CC) process. In certain embodiments, each chemical process uses a particular protocol. In various embodiments, only a subset of the one or more chemical processes are performed at a given time and in any desired order.

In some examples, the DP process uses the following protocol: submerge once in xylene for 3 minutes, submerge once in fresh xylene for 4 minutes, submerge once in fresh xylene for 5 minutes, submerge twice in 100% ethanol for 3 minutes each, submerge once in 90% ethanol for 3 minutes, submerge once in 70% ethanol for 3 minutes, submerge once in 50% ethanol for 3 minutes, and submerge once in distilled water for 5 minutes.

In certain examples, the HIS process uses the following protocol: submerge in Mayer's hematoxylin for 5 minutes, submerge in tap water for 5 minutes, submerge in eosin Y for 2 minutes, wash with 70% reagents alcohol for 30 seconds to remove excess eosin, and submerge in distilled water for at least 3 minutes and up to 3 hours. In some embodiments, other staining types include trichrome, pentachrome, Verhoeff-Van Gieson stain and/or periodic acid-Schiff.

In some examples, the AR process uses the following protocol: add PBS, mix PBS and trypsin solution from an antigen retrieval kit in a 1:1 ratio, incubate with trypsin solution for 10 minutes at room temperature, and rinse five times with PBS.

In certain examples, the IHC process uses the following protocol: incubate in 3% hydrogen peroxide in (diluted once from 30% PBS) for 10 minutes, rinse in PBS for five times, block at room temperature for 10 minutes in a blocking buffer (5% glycerol, 5% cold water fish skin gelatin, 5% normal serum, 85% PBS), incubate in primary Ab (diluted in blocking buffer) for 1 hour at room temperature in humid chamber, rinse in PBS for five times, incubate in ready-to-use secondary antibody for 30 minutes at room temperature, rinse in PBS for five times, incubate in DAB for 15 minutes, and stop reaction by rinsing for 5 minutes in deionized water. In some embodiments, IHC counterstaining uses the above protocol with two additional steps: incubate in Mayer's hematoxylin for 15 minutes at room temperature and incubate in 0.1% sodium bicarbonate for 5 minutes at room temperature.

In some examples, the LP process uses the following protocol: use a lysis kit, pipette in 50 μL of lysis buffer, seal in humid environment provided by RNAse-free water, hold at 60° C. for 90 minutes, hold at −20° C. for 2 minutes, pipette out lysis buffer and into LoBind RNAse-free microfuge tubes, and proceed with rest of lysis kit as outlined in kit manual.

In certain examples, the IF process uses the following protocol: transfer to magnetic staining plate, apply PBS liberally to keep wet, transfer off PBS, apply a blocking buffer, incubate for 30 minutes, dilute primary antibody to appropriate dilution in blocking buffer, transfer off blocking buffer, apply primary antibody, incubate in the dark with primary antibody for 1 hour at room temperature or overnight in a humid environment at 4° C., remove primary antibody, washed five times with PBS, apply secondary antibody, incubate for 1 hour at room temperature in the dark, remove secondary antibody, and wash five times with PBS in the dark.

In some examples, the ISH process uses the following protocol: perform DP and AR processes, wash five times in distilled water, immerse in ice cold 20% acetic acid for 20-30 seconds, apply a 1 minute wash of 70% ethanol, apply a 1 minute wash of 95% ethanol, apply a 1 minute wash of 100% ethanol, air dry, immerse in hybridization solution (formamide, salts, Denhardt's solution, dextran sulphate, heparin, SDS), incubate in humid environment at 60° C. for 1 hour, dilute probes in hybridization solution, heat at 95° C. for 2 minutes, chill on ice, remove hybridization solution, add diluted probes, incubate in humid environment at 65° C. overnight, wash in Wash 1 (formamide in saline sodium citrate) three times for 5 minutes each at 37-45° C., wash in Wash 2 (saline sodium citrate) three times for 5 minutes each at 25-75° C., wash twice in MABT (maleic acid buffer Tween 20) for 30 minutes at room temperature, dry and place back in humid environment, add blocking buffer (MABT+BSA/milk/serum), incubate for 1-2 hours, remove blocking buffer, add secondary antibody, incubate for 1-2 hours at room temperature, wash five times for 10 minutes each with MABT at room temperature, wash twice for 10 minutes each with prestaining buffer (Tris/NaCl/MgCl2), place back in humid environment, and perform color development.

In some examples, the ST process uses the following protocol: coat substrate with spatially encoded DNA barcode array, lyse and capture onto barcode array, optionally ligate mRNA transcripts with array, and dissociate barcoded mRNA transcripts from substrate and extract.

In certain examples, the MT process uses the following protocol: cover in distilled water, drop one drop of mountant solution (30 g fructose in 13 mL distilled water), leave meniscus of mountant solution, laminate with cover film.

In some examples, the CC process uses the following protocol: optionally dissociate cells, maintain in controlled environment, and extract cells for additional analysis.

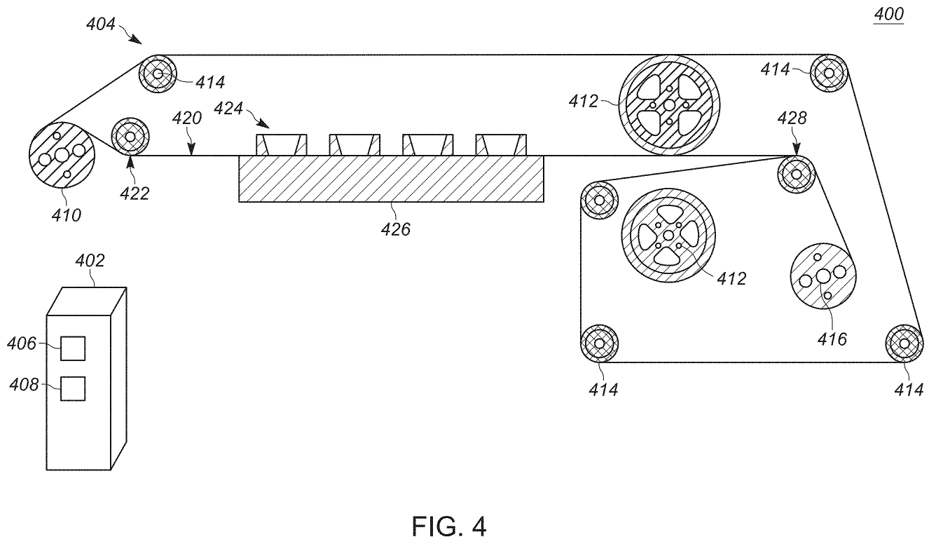

FIG. 4 shows a simplified system for processing biological specimens according to certain embodiments of the present disclosure. This figure is merely an example, which should not unduly limit the scope of the claims. One of ordinary skill in the art would recognize many variations, alternatives, and modifications. The system 400 includes a computing device 402 and a roller system 404. Although the above has been shown using a selected group of components for the system, there can be many alternatives, modifications, and variations. For example, some of the components may be expanded and/or combined. Other components may be inserted to those noted above. Depending upon the embodiment, the arrangement of components may be interchanged with others replaced.

In various embodiments, the computing device 402 is communicatively coupled to the roller system 404 for implementing the methods described in the present disclosure. For example, the computing device 402 executes one or more operations to implement the method 200 and/or the method 300. In certain embodiments, the computing device 402 includes a processor 406 and a memory 408. For example, the processor 406 is configured to execute instructions to perform the various operations associated with the method 200 and/or the method 300. As an example, the instructions are stored in the memory 408.

In some embodiments, the roller system 404 includes a starting roller 410, one or more driver rollers 412, one or more guide rollers 414, and a finishing roller 416. For example, the roller system 404 operates to move a continuous substrate 420.

In certain embodiments, a plurality of biological specimens are attached to the continuous substrate 420. In some embodiments, the plurality of biological specimens are initially protected by a cover (e.g., protective liner). In certain embodiments, the plurality of biological specimens are uncovered at a location 422 in the roller system 404. In some embodiments, after uncovering the plurality of biological specimens, a plurality of wells 424 and a base 426 cooperate to attach the plurality of wells 424 to the continuous substrate 420, where each well is configured to surround a respective biological specimen on the continuous substrate 420.

In various embodiments, the plurality of biological specimens in the plurality of wells 424 are chemically processed simultaneously. In some embodiments, after chemical processing, the plurality of wells 424 are detached from the continuous substrate 420. In certain embodiments, the plurality of biological specimens are re-covered for protection at a location 428 in the roller system 404.

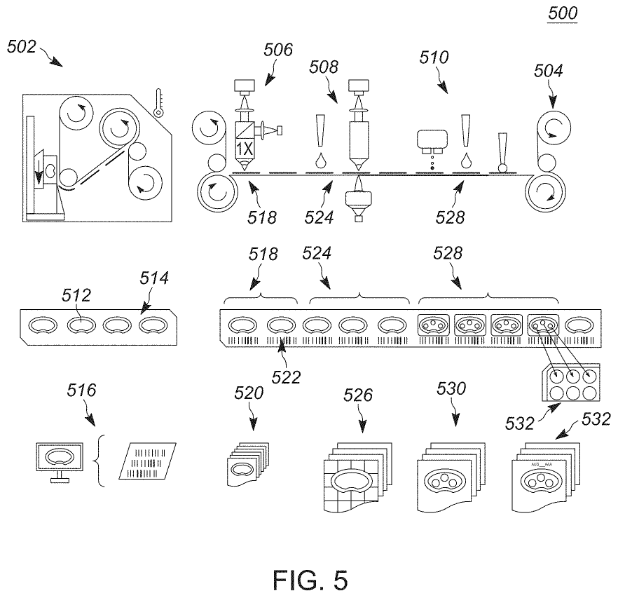

FIG. 5 shows a simplified system of an automated workcell for processing biological specimens according to certain embodiments of the present disclosure. This figure is merely an example, which should not unduly limit the scope of the claims. One of ordinary skill in the art would recognize many variations, alternatives, and modifications. The system 500 includes a cryotome 502, a roller system 504, an imaging station 506, and one or more assay stations 508, 510. Although the above has been shown using a selected group of components for the system, there can be many alternatives, modifications, and variations. For example, some of the components may be expanded and/or combined. Other components may be inserted to those noted above. Depending upon the embodiment, the arrangement of components may be interchanged with others replaced.

In certain embodiments, one or more biological specimens 512 are prepared in the cryotome 502. For example, the one or more biological specimens 512 are covered with a protective liner and placed under freezing condition until needed. In some embodiments, the one or more biological specimens 512 may be non-frozen (e.g., paraffin sections).

In various embodiments, the one or more biological specimens 512 are attached to a continuous substrate 514. For example, the continuous substrate 514 is formed by a continuous sheet of tape. In certain embodiments, metadata 516 associated with each of the one or more biological specimens 512 are determined and recorded. For example, the metadata 516 include information such as a position of each biological specimen on the continuous substrate 514, an origin or source of each biological specimen, instructions for an intended chemical process of each biological specimen, etc.

In some embodiments, the roller system 504 moves the continuous substrate 514 to facilitate movement of the one or more biological specimens 512 between different stations. In certain embodiments, visual inspection is performed at a location 518 on the continuous substrate 514 by the imaging station 506. For example, machine vision can be employed to align and verify the placement of the one or more biological specimens 512 on the continuous substrate 514. As an example, the resulting data are digitally registered into a Z-stack dataset 520. In various embodiments, each of the one or more biological specimens 512 may be identified by a respective label 522 (e.g., a barcode).

In certain embodiments, one or more chemical processes are performed at the one or more assay stations 508, 510. For example, at a location 524 on the continuous substrate 514, the one or more biological specimens 512 are stained for imaging by the assay station 508. As an example, whole slide imaging scans 526 are performed on the one or more biological specimens 512 by the assay station 508. For example, at a location 528 on the continuous substrate 514, the one or more biological specimens 512 are masked and lysed by the assay station 510. As an example, the lysed materials 530 are extracted for further analysis 532 by the assay station 510.

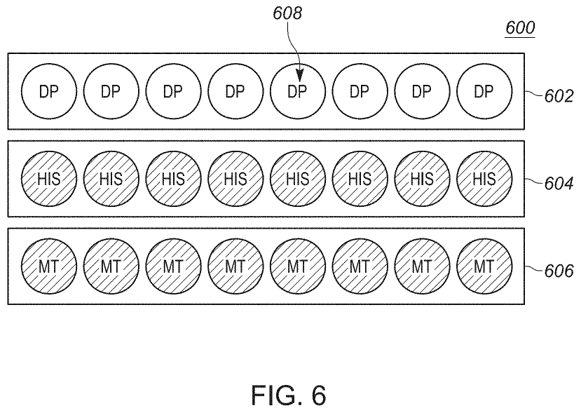

FIG. 6 to FIG. 19 show simplified diagrams of workflows for processing biological specimens according to certain embodiments of the present disclosure. The figures are merely examples, which should not unduly limit the scope of the claims. One of ordinary skill in the art would recognize many variations, alternatives, and modifications.

FIG. 6 shows a workflow 600 used in histological staining of specimens for 3D imaging according to certain embodiments of the present disclosure. In some embodiments, the workflow 600 includes steps 602, 604 and 606. For example, in the step 602, the DP process is performed on one or more biological specimens 608. As an example, in the step 604, the HIS process is performed on the one or more biological specimens 608. For example, in the step 606, the MT process is performed on the one or more biological specimens 608.

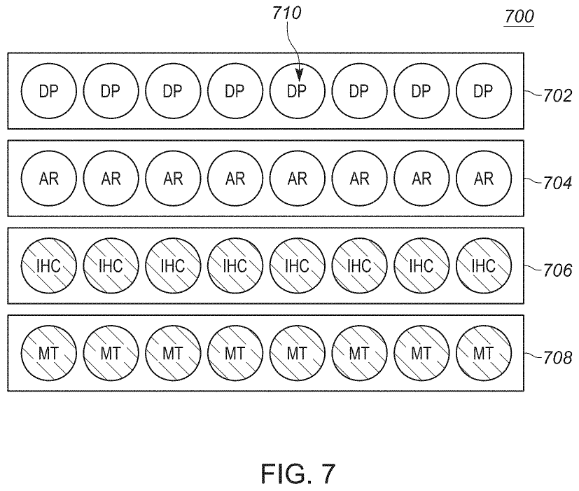

FIG. 7 shows a workflow 700 used in immunohistochemical staining of specimens for 3D imaging according to certain embodiments of the present disclosure. In some embodiments, the workflow 700 includes steps 702, 704, 706 and 708. For example, in the step 702, the DP process is performed on one or more biological specimens 710. As an example, in the step 704, the AR process is performed on the one or more biological specimens 710. For example, in the step 706, the IHC process is performed on the one or more biological specimens 710. As an example, in the step 708, the MT process is performed on the one or more biological specimens 710.

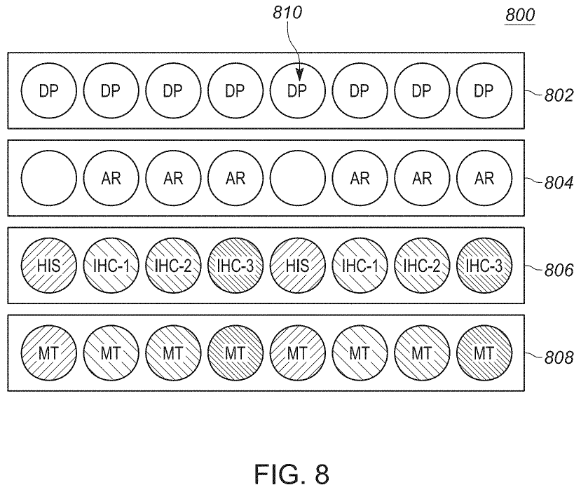

FIG. 8 shows a workflow 800 used in mixed histological and/or immunohistochemical staining panel of specimens for imaging according to certain embodiments of the present disclosure. In some embodiments, the workflow 800 includes steps 802, 804, 806 and 808. For example, in the step 802, the DP process is performed on one or more biological specimens 810. As an example, in the step 804, the AR process is performed on selected one or more biological specimens 810. For example, in the step 806, different IHC processes are performed on the one or more biological specimens 810 that were selected for the AR process, while the HIS process is performed on the one or more biological specimens 810 that were not selected for the AR process. As an example, in the step 808, the MT process is performed on the one or more biological specimens 810.

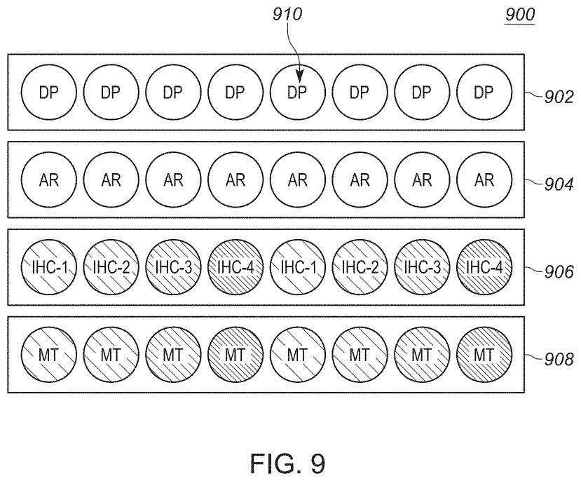

FIG. 9 shows a workflow 900 used in immunohistochemical staining panel of specimens for imaging according to certain embodiments of the present disclosure. In some embodiments, the workflow 900 includes steps 902, 904, 906 and 908. For example, in the step 902, the DP process is performed on one or more biological specimens 910. As an example, in the step 904, the AR process is performed on the one or more biological specimens 910. For example, in the step 906, different IHC processes are performed on the one or more biological specimens 910. As an example, in the step 908, the MT process is performed on the one or more biological specimens 910.

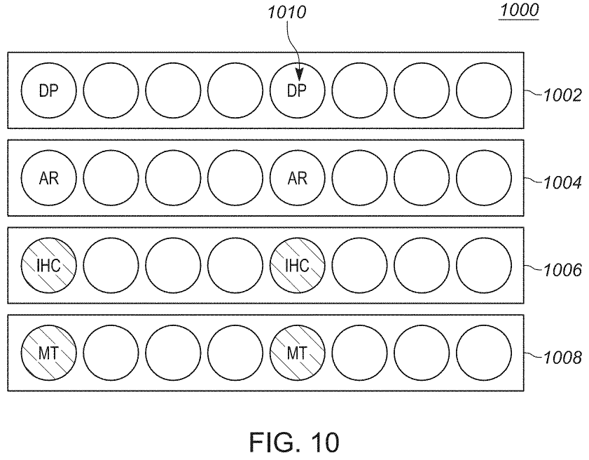

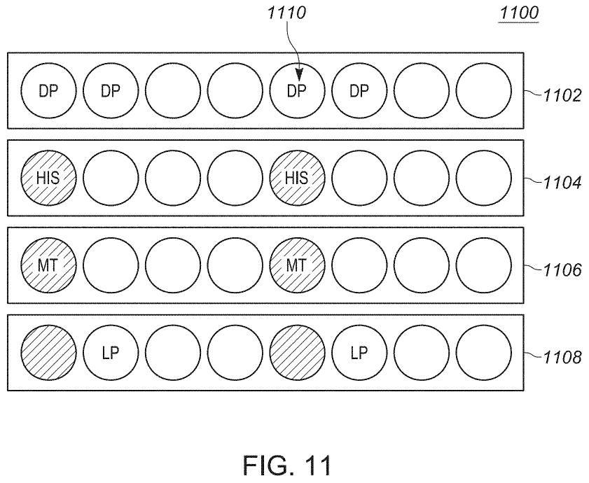

FIG. 10 shows a workflow 1000 used in interval immunohistochemical sampling of specimens according to according to certain embodiments of the present disclosure. In some embodiments, the workflow 1000 includes steps 1002, 1004, 1006 and 1008. For example, in the step 1002, the DP process is performed on selected one or more biological specimens 1010. As an example, in the step 1004, the AR process is performed on the selected one or more biological specimens 1010. For example, in the step 1006, the IHC process is performed on the one or more biological specimens 1010 that were selected for the DP and AR processes. As an example, in the step 1008, the MT process is performed on the one or more biological specimens 1010 that were selected for the IHC process.

FIG. 11 shows a workflow 1100 used in RNA extraction with adjacent stained specimens according to certain embodiments of the present disclosure. In some embodiments, the workflow 1100 includes steps 1102, 1104, 1106 and 1108. For example, in the step 1102, the DP process is performed on selected one or more biological specimens 1110. As an example, in the step 1104, the HIS process is performed on some of the selected one or more biological specimens 1110 that were selected for the DP process. For example, in the step 1106, the MT process is performed on the one or more biological specimens 1110 that were selected for the HIS process. As an example, in the step 1108, the LP process is performed on biological specimens that are adjacent to the one or more biological specimens 1110 that were selected for the MT process.

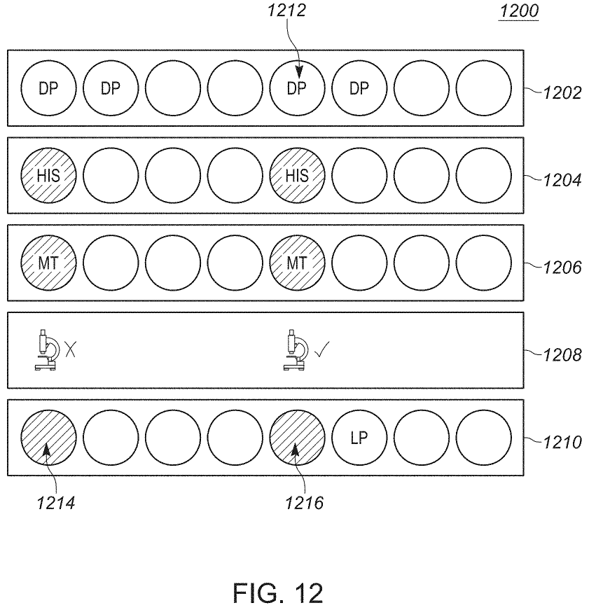

FIG. 12 shows a workflow 1200 used in image-based selection of specimens for RNA extraction according to certain embodiments of the present disclosure. In some embodiments, the workflow 1200 includes steps 1202, 1204, 1206, 1208 and 1210. For example, in the step 1202, the DP process is performed on selected one or more biological specimens 1212. As an example, in the step 1204, the HIS process is performed on some of the one or more biological specimens 1212 that were selected for the DP process. For example, in the step 1206, the MT process is performed on the one or more biological specimens 1212 that were selected for the HIS process. As an example, in the step 1208, visual inspection is performed (e.g., via a digital microscope) on the one or more biological specimens 1212 that were selected for the MT process. For example, a specimen sample 1214 fails visual inspection, while a specimen sample 1216 passes visual inspection. As an example, in the step 1210, based on the visual inspection, the LP process is performed on a biological specimen that is adjacent to the specimen sample 1216 that passed visual inspection.

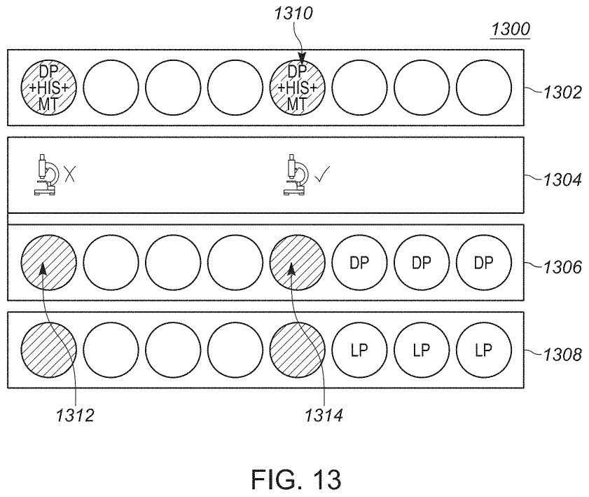

FIG. 13 shows a workflow 1300 used in image-based selection of specimens via pooled RNA extraction according to certain embodiments of the present disclosure. In some embodiments, the workflow 1300 includes steps 1302, 1304, 1306 and 1308. For example, in the step 1302, the DP, HIS and MT processes are performed on selected one or more biological specimens 1310. As an example, in the step 1304, visual inspection is performed (e.g., via a digital microscope) on the one or more biological specimens 1310 that were selected for the DP, HIS and MT processes. For example, a specimen sample 1312 fails visual inspection, while a specimen sample 1314 passes visual inspection. As an example, in the step 1306, based on the visual inspection, the DP process is performed on selected neighboring biological specimens to the specimen sample 1314 that passed visual inspection. For example, in the step 1308, the LP process is performed on the neighboring biological specimens that were selected for the DP process.

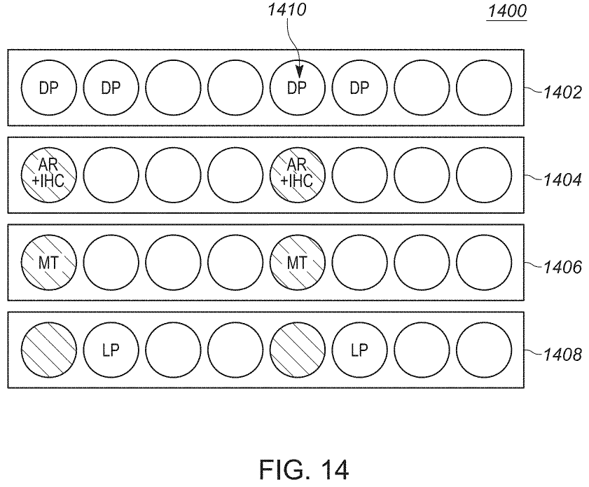

FIG. 14 shows a workflow 1400 used in RNA transcript validation of antigen staining of specimens according to certain embodiments of the present disclosure. In some embodiments, the workflow 1400 includes steps 1402, 1404, 1406 and 1408. For example, in the step 1402, the DP process is performed on selected one or more biological specimens 1410. As an example, in the step 1404, the AR and IHC processes are performed on some of the one or more biological specimens 1410 that were selected for the DP process. For example, in the step 1406, the MT process is performed on the one or more biological specimens 1410 that were selected for the AR and IHC processes. As an example, in the step 1408, the LP process is performed on biological specimens that are adjacent to the one or more biological specimens 1410 that were selected for the MT process.

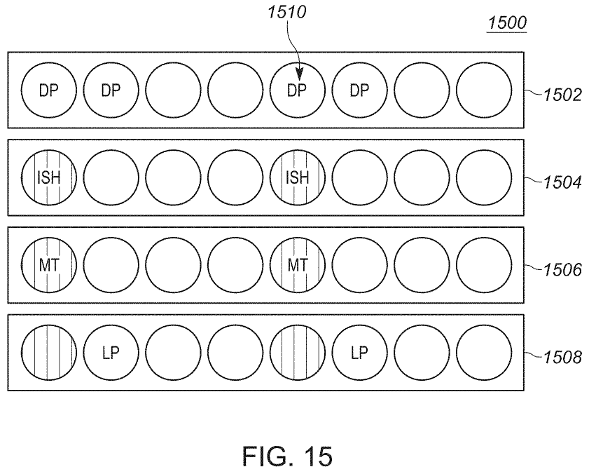

FIG. 15 shows a workflow 1500 used in ISH probe validation of specimens according to certain embodiments of the present disclosure. In some embodiments, the workflow 1500 includes steps 1502, 1504, 1506 and 1508. For example, in the step 1502, the DP process is performed on selected one or more biological specimens 1510. As an example, in the step 1504, the ISH process is performed on some of the one or more biological specimens 1510 that were selected for the DP process. For example, in the step 1506, the MT process is performed on the one or more biological specimens 1510 that were selected for the ISH process. As an example, in the step 1508, the LP process is performed on biological specimens that are adjacent to the one or more biological specimens 1510 that were selected for the MT process.

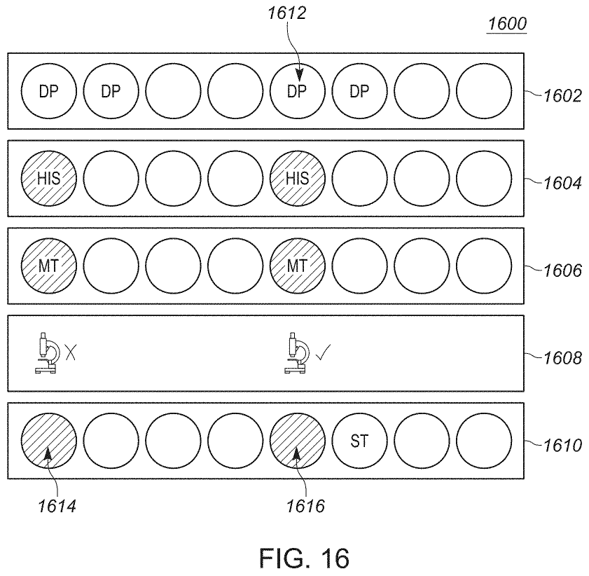

FIG. 16 shows a workflow 1600 used in image-based selection of specimens for spatial transcriptomics according to certain embodiments of the present disclosure. In some embodiments, the workflow 1600 includes steps 1602, 1604, 1606, 1608 and 1610. For example, in the step 1602, the DP process is performed on selected one or more biological specimens 1612. As an example, in the step 1604, the HIS process is performed on some of the one or more biological specimens 1612 that were selected for the DP process. For example, in the step 1606, the MT process is performed on the one or more biological specimens 1612 that were selected for the HIS process. As an example, in the step 1608, visual inspection is performed (e.g., via a digital microscope) on the one or more biological specimens 1612 that were selected for the MT process. For example, a specimen sample 1614 fails visual inspection, while a specimen sample 1616 passes visual inspection. As an example, in the step 1610, based on the visual inspection, the ST process is performed on a biological specimen that is adjacent to the specimen sample 1616 that passed visual inspection.

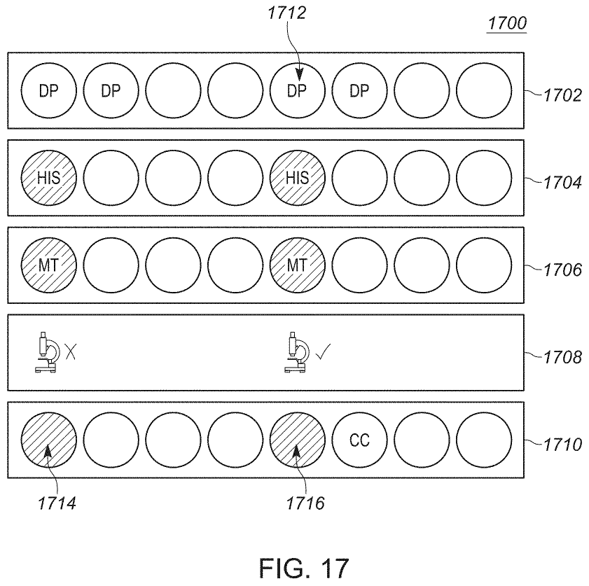

FIG. 17 shows a workflow 1700 used in image-based selection of specimens for cell culture development according to certain embodiments of the present disclosure. In some embodiments, the workflow 1700 includes steps 1702, 1704, 1706, 1708 and 1710. For example, in the step 1702, the DP process is performed on selected one or more biological specimens 1712. As an example, in the step 1704, the HIS process is performed on some of the one or more biological specimens 1712 that were selected for the DP process. For example, in the step 1706, the MT process is performed on the one or more biological specimens 1712 that were selected for the HIS process. As an example, in the step 1708, visual inspection is performed (e.g., via a digital microscope) on the one or more biological specimens 1712 that were selected for the MT process. For example, a specimen sample 1714 fails visual inspection, while a specimen sample 1716 passes visual inspection. For example, in the step 1710, based on the visual inspection, the CC process is performed on a biological specimen that is adjacent to the specimen sample 1716 that passed visual inspection.

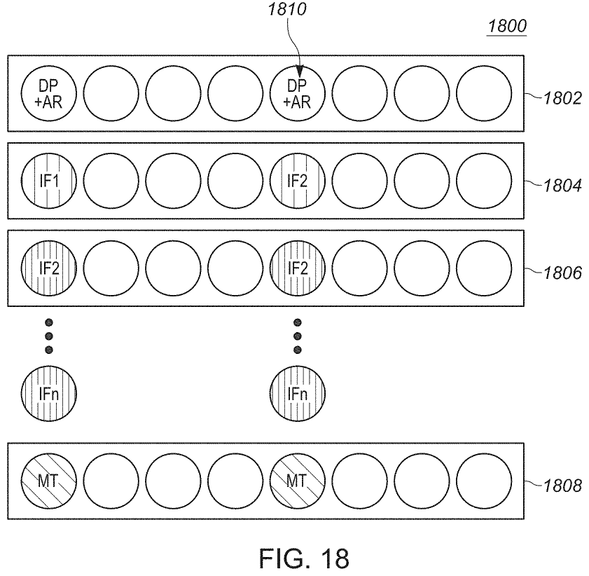

FIG. 18 shows a workflow 1800 used in multiplex immunofluorescence of specimens according to certain embodiments of the present disclosure. In some embodiments, the workflow 1800 includes steps 1802, 1804, 1806 and 1808. For example, in the step 1802, the DP and AR processes are performed on selected one or more biological specimens 1810. As an example, in the step 1804, a first IF process is performed on the one or more biological specimens 1810 that were selected for the DP and AR processes. For example, in the step 1806, a second IF process is performed on the one or more biological specimens 1810 that were selected for the DP and AR processes. As an example, the steps 1804 and/or 1806 may be repeated for n times. For example, in the step 1808, the MT process is performed on the one or more biological specimens 1810 that were selected the multiple IF processes.

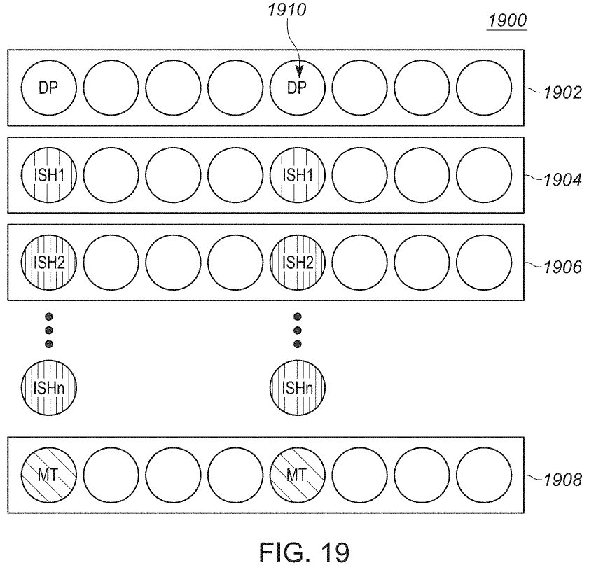

FIG. 19 shows a workflow 1900 used in multiplex fluorescence in situ hybridization of specimens according to certain embodiments of the present disclosure. In some embodiments, the workflow 1900 includes steps 1902, 1904, 1906 and 1908. For example, in the step 1902, the DP process is performed on selected one or more biological specimens 1910. As an example, in the step 1904, a first ISH process is performed on the one or more biological specimens 1910 that were selected for the DP process. For example, in the step 1906, a second ISH process is performed on the one or more biological specimens 1910 that were selected for the DP process. As an example, the steps 1904 and/or 1906 may be repeated for n times. For example, in the step 1908, the MT process is performed on the one or more biological specimens 1910 that were selected the multiple IF processes.

In various embodiments, the workflows 600 to 1900 shown in FIG. 6 to FIG. 19, respectively collect data from one or more biological specimens. In some embodiments, the data are used for microscope imagery where chemical processing provides contrast to the underlying tissue (see FIGS. 6-10, FIG. 18 and FIG. 19). For example, the contrast is shown by histological staining to highlight microscopic morphology of cells and tissue, immunohistochemical and immunofluorescence staining to highlight specific phenotypic markers, and/or in situ hybridization to highlight genotype or expression of known genes. In certain embodiments, a series of stained biological specimens, not necessarily contiguous, is imaged on a microscope and optionally digitally registered into a Z-stack dataset. In some embodiments, multiple contiguous biological specimens are stained with the same type of contrast such that the resulting Z-stack dataset describes a 3D reconstruction of the tissue (see FIG. 6 and FIG. 7).

In certain embodiments, different types of contrast can be combined to support correlative and multi-channel images such that images in adjacent specimens provide complementary knowledge of cell and tissue states (see FIG. 8 and FIG. 9). In some embodiments, multiple types of contrast can be added sequentially to the same biological specimens, as in the case of multiplex immunofluorescence labeling (see FIG. 18). In certain embodiments, the workflows may explicitly skip staining of some specimens in order to sample through the depth dimension of a tissue volume without the expense of staining and imaging every specimen while preserving untreated specimens for optional follow-up steps (see FIG. 10).

In some embodiments, the data are a combination of microscope imagery and molecular assay results (see FIGS. 11-17). For example, molecular assays offer complementary data to imagery or the imagery may be used to select high-priority regions of tissue for analysis where time, reagents, and/or tissue are scarce. In certain embodiments, the image in a single specimen can be used to identify multiple adjacent specimens for molecular analysis (see FIG. 13), where all specimens are pooled together to boost signal or separately analyzed (e.g., in RT-PCR assays for distinct genes).

According to certain embodiments, a method for processing biological specimens includes loading a plurality of biological specimens on a continuous substrate at a plurality of spaced-apart locations on the continuous substrate. Also, the method includes attaching a plurality of wells to the continuous substrate corresponding to the plurality of spaced-apart locations. Each well of the plurality of wells is configured to surround a respective biological specimen of the plurality of biological specimens on the continuous substrate. Further, the method includes performing one or more chemical processes on the respective biological specimen contained in the each well of the plurality of wells. Moreover, the method includes analyzing results of the one or more chemical processes on the respective biological specimen contained in the each well of the plurality of wells. For example, the method is implemented according to at least FIG. 3.

According to some embodiments, a system for processing biological specimens includes one or more processors and a memory storing instructions for execution by the one or more processors. The instructions, when executed by the one or more processors, cause the system to load a plurality of biological specimens on a continuous substrate at a plurality of spaced-apart locations on the continuous substrate. Also, the instructions, when executed by the one or more processors, cause the system to attach a plurality of wells to the continuous substrate corresponding to the plurality of spaced-apart locations. Each well of the plurality of wells is configured to surround a respective biological specimen of the plurality of biological specimens on the continuous substrate. Further, the instructions, when executed by the one or more processors, cause the system to perform one or more chemical processes on the respective biological specimen contained in the each well of the plurality of wells. Moreover, the instructions, when executed by the one or more processors, cause the system to process results of the one or more chemical processes on the respective biological specimen contained in the each well of the plurality of wells. For example, the system is implemented according to at least FIG. 4 and/or FIG. 5.

For example, some or all components of various embodiments of the present disclosure each are, individually and/or in combination with at least another component, implemented using one or more software components, one or more hardware components, and/or one or more combinations of software and hardware components. In another example, some or all components of various embodiments of the present disclosure each are, individually and/or in combination with at least another component, implemented in one or more circuits, such as one or more analog circuits and/or one or more digital circuits. In yet another example, while the embodiments described above refer to particular features, the scope of the present disclosure also includes embodiments having different combinations of features and embodiments that do not include all of the described features. In still another example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Certain implementations may also be used, however, such as firmware or even appropriately designed hardware configured to perform the methods and systems described herein.

The systems' and methods' data (e.g., associations, mappings, data input, data output, intermediate data results, final data results) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the present disclosure is not to be limited by the specific illustrated embodiments.

What is claimed is:

1. A method for processing biological specimens, the method comprising:
loading, by a system, a plurality of biological specimens on a continuous substrate at a plurality of spaced-apart locations on the continuous substrate;
attaching, by the system, a plurality of wells to the continuous substrate corresponding to the plurality of spaced-apart locations, each well of the plurality of wells being configured to surround a respective biological specimen of the plurality of biological specimens on the continuous substrate;
performing, by the system, one or more chemical processes on the respective biological specimen contained in the each well of the plurality of wells; and
processing, by the system, results of the one or more chemical processes on the respective biological specimen contained in the each well of the plurality of wells.

2. The method of claim 1, further comprising:
uncovering, by the system, the plurality of biological specimens prior to attaching the plurality of wells to the continuous substrate.

3. The method of claim 2, further comprising:
detaching, by the system, the plurality of wells from the continuous substrate; and
after detaching the plurality of wells, covering, by the system, the plurality of biological specimens for protection.

4. The method of claim 1, wherein the one or more chemical processes include one or more processes of a deparaffinization process, a histological staining process, an antigen retrieval process, an immunohistochemical staining process, a lysis process, an immunofluorescence staining process, an in situ hybridization process, a spatial transcriptomics process, a mounting cover film process, and a cell culture development process.

5. The method of claim 1, wherein the performing, by the system, the one or more chemical processes includes adding one or more reagents to the respective biological specimen contained in the each well of the plurality of wells.

6. The method of claim 1, wherein the attaching, by the system, the plurality of wells to the continuous substrate includes sealing each well of the plurality of wells.

7. The method of claim 1, further comprising:
recording, by the system, spatial coordinates of each well on the continuous substrate.

8. The method of claim 1, further comprising:
identifying, by the system, one or more first wells of the plurality wells, the one or more first wells surrounding one or more first biological specimens of the plurality of biological specimens respectively, the one or more first biological specimens being subject to one or more first chemical processes of the one or more chemical processes; and
recording, by the system, the identified one or more first wells.

9. The method of claim 8, further comprising:
identifying, by the system, one or more second wells of the plurality wells, the one or more second wells surrounding one or more second biological specimens of the plurality of biological specimens respectively, the one or more second biological specimens being subject to one or more second chemical processes of the one or more chemical processes; and
recording, by the system, the identified one or more second wells.

10. The method of claim 8, further comprising:
identifying, by the system, one or more second wells of the plurality wells, the one or more second wells surrounding one or more second biological specimens of the plurality of biological specimens respectively, the one or more second biological specimens not being subject to any chemical processes of the one or more chemical processes; and
recording, by the system, the identified one or more second wells.

11. A system for processing biological specimens, the system comprising:
one or more processors; and
a memory storing instructions that, when executed by the one or more processors, cause the system to:
load a plurality of biological specimens on a continuous substrate at a plurality of spaced-apart locations on the continuous substrate;
attach a plurality of wells to the continuous substrate corresponding to the plurality of spaced-apart locations, each well of the plurality of wells being configured to surround a respective biological specimen of the plurality of biological specimens on the continuous substrate;
perform one or more chemical processes on the respective biological specimen contained in the each well of the plurality of wells; and
process results of the one or more chemical processes on the respective biological specimen contained in the each well of the plurality of wells.

12. The system of claim 11, wherein the instructions, when executed by the one or more processors, further cause the system to:
uncover the plurality of biological specimens prior to attaching the plurality of wells to the continuous substrate.

13. The system of claim 12, wherein the instructions, when executed by the one or more processors, further cause the system to:
detach the plurality of wells from the continuous substrate; and
after detaching the plurality of wells, cover the plurality of biological specimens for protection.

14. The system of claim 11, wherein, the instructions that cause the system to perform the one or more chemical processes further comprise instructions that cause the system to add one or more reagents to the respective biological specimen contained in the each well of the plurality of wells.

15. The system of claim 11, wherein, the instructions that cause the system to attach the plurality of wells to the continuous substrate further comprise instructions that cause the system to seal each well of the plurality of wells.

16. The system of claim 11, wherein the instructions, when executed by the one or more processors, further cause the system to:
record spatial coordinates of each well on the continuous substrate.

17. The system of claim 11, wherein the instructions, when executed by the one or more processors, further cause the system to:
identify one or more first wells of the plurality wells, the one or more first wells surrounding one or more first biological specimens of the plurality of biological specimens respectively, the one or more first biological specimens being subject to one or more first chemical processes of the one or more chemical processes; and
record the identified one or more first wells.

18. The system of claim 17, wherein the instructions, when executed by the one or more processors, further cause the system to:
identify one or more second wells of the plurality wells, the one or more second wells surrounding one or more second biological specimens of the plurality of biological specimens respectively, the one or more second biological specimens being subject to one or more second chemical processes of the one or more chemical processes; and
record the identified one or more second wells.

19. The system of claim 17, wherein the instructions, when executed by the one or more processors, further cause the system to:
identify one or more second wells of the plurality wells, the one or more second wells surrounding one or more second biological specimens of the plurality of biological specimens respectively, the one or more second biological specimens not being subject to any chemical processes of the one or more chemical processes; and
record the identified one or more second wells.

20. The system of claim 11, wherein the one or more chemical processes include one or more processes of a deparaffinization process, a histological staining process, an antigen retrieval process, an immunohistochemical staining process, a lysis process, an immunofluorescence staining process, an in situ hybridization process, a spatial transcriptomics process, a mounting cover film process, and a cell culture development process.
